(19) United States
(12) Patent Application Publication
(10) Pub. No.: US 2012/0061975 A1
(43) Pub. Date: Mar. 15, 2012

(54) Spring and dead bolt latch

(76) Inventor: Edward William O'Hanlon, Tucson, AZ (US)

(21) Appl. No.: 13/135,253

(22) Filed: Jun. 30, 2011

Related U.S. Application Data
(60) Provisional application No. 61/403,294, filed on Sep. 13, 2010.

(51) Int. Cl. E05C 1/08

(52) U.S. Cl. 292/164

(57) ABSTRACT

A latching device consisting of three annuli held concentically together by means of cotter pins and inserted between the door handle assembly and the door surface being part of a doorway upon which door an existing mounted spring or dead bolt lock is installed such that a slide plate contained within a slot cut into the center annulus diameter can straddle the drive shaft of the existing lock when the slide plate is slid into the lock housing thus latching the drive shaft to lock housing, and conversely being unlatched when the slide plate is withdrawn from from the lock assembly, the whole being held in place by the cotter pins bearing upon the inside diameter of the lock mounting hole and thence clamped between the lock handle assembly and the door surface in its final installed condition.

### BACKGROUND OF THE INVENTION

All door locks, of either the spring bolt type, or the dead bolt type, are controlled externally by some form of key, or push button, or other electronic means of operation. Inherent in these methods of control are the fundamental limitations of the security which these locks are presumed to provide,

In rhe instance of the key operation, lost or stolen keys, duplicate keys, lock picks or metal shims (as used in spring bolts) are alternative means of entry. As to the push button type of lock control, a spray of silicon on the push buttons done prior to a legal entry will reveal the combination numbers when can ten be readily permutated to provide the means of entry.

Electronic means of entry, based upon cell phone numbers, which can be read or stolen, are equally vulnerable in their own right, apart from the fact that this type of control usually has the push button system as a back up control means.

From the above it is axiomatic that the locking means which has a sole control such as a key, push button or other means is vulnerable to illegal entry simply because the ultimate control means is ‘external’ to the door which, by various means can be copied. The ‘BUMP” keys are an example of how any cylinder lock used on all locks can be readily opened by anyone.

A latching device made in accordance with this invention will anchor the lock drive shaft to the lock housing thus allowing the person within the establishment, which has an existing installed lock, to lock the door in such a manner that the lock cannot be operated from the outside of the door by any means even using a key or even if the lock is drilled out by a locksmith or an intruder thus the latch is providing the ultimate in door security.

### SUMMARY OF THE INVENTION

The spring bolt and dead bolt lock latching device consists of three annular shapes mounted atop each other in sandwich form and of such diameters that they are larger than the diameter of the lock mounting handle assembly and also the lock mounting hole space in a door designated as part of a doorway. The cotter pins holding the annuli together extend into and bear upon the lock mounting hole diameter thus holding the latch assembly in place in the mounting hole until the lock handle assembly is assembled on to the lock.

The center annulus of the three annuli assembly is cut in such a manner that a gap is formed between the upper and lower annuli at some precise location into which gap a metal slide plate is inserted this slide plate having such a shape that when it is extended fully into the lock housing volume it straddles the existing lock drive shaft thus holding this drive shaft in a fixed position and so preventing any movement of the lock mechanism. This slide plate shape is such that it can straddle, and hold stationary, any of the various shapes and sizes of lock drive shafts available at present.

Upon withdrawing the slide plate from the lock housing the lock can be operated as normal.

A latching device made in accordance with this invention holds a lock mechanism in its locked condition by latching the lock drive shaft to the lock housing such that all external means of opening the door are obviated.

A latching system made in accordance with this invention transfers the complete control of the locking system and thus its security to the person who controls the lock from the inside of the door thus ensuring an increased security than that normally provided by the existing lock alone.

The above stated and other objects and advantages of the invention will become apparent from the following descriptions when taken with the accompanying drawings and descriptions. It will be understood however that the drawings are for purposes of illustration and are not to be construed as defining the scope or limits of the invention, references being had for the latter purpose to the claims appended hereto.

### BRIEF DESCRIPTION OF THE DRAWINGS

In the drawings wherein like parts reference characters denote like parts in the several views.

FIG. 1 shows a plan view of the complete latching device mounted on to the lock mounting hole (shown dotted) and holding the lock drive shaft in its locked and latched condition.

FIG. 2 shows an elevation view of the latch as seen from the bottom of the door and through the door.

FIG. 3 shows a pictorial view of the slide plate.

FIG. 4 shows a plan view of the latch with its slide plate withdrawn thus allowing normal operation of the lock.

FIG. 5 shows the center annulus of the three annuli assembly with the gap which accomodates the slide plate mechanism.

FIG. 6 shows a plan view of the top and bottom annuli which are identical.

FIG. 7 shows a plan view of a typical spring bolt lock drive shaft.

FIG. 8 shows a plan view of a single dead bolt lockdrive shaft.

FIG. 9 shows a plan view of a double dead bolt lock drive shaft.

FIG. 10 shows a pictorial view of the latch mounted on a door with the lock handle assembly raised up from the door to show its relationship to the lock mechanism.

### DESCRIPTION OF THE PREFERRED EMBODIMENT

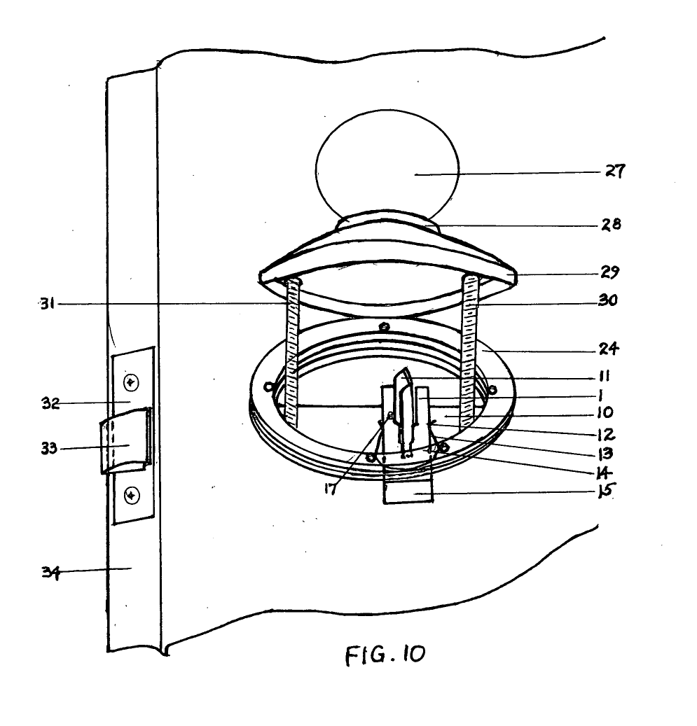

The housing for the latch is shown in FIG. 6 in which annulus (24), which is identical to annulus (26) are the top and bottom annuli respectively of the three annuli assembly which also shows their corresponding cotter pin drilled holes (4) (5) (6) (7) and (8) these said annuli (24) and (26) being mounted above and below the annulus (25) which is shown with a gap cut into its circumference (21) in FIG. 5, the whole being assembled together and held in place by the cotter pins inserted through holes (4) (5) (6) (7) and (8).

FIG. 1 shows a plan view of the latch (1) mounted on a door, being part of a doorway, with its arms (2) and (3) straddling the drive shaft (11) such that the cotter pins when inserted into holes (4) (5) (6) (7) and (8) and so protrude into, and bear upon, the inside diameter of the lock mounting hole (9) hold the latch assembly temporarily in place. The diameter of the lock mounting hole (9) is shown by the dotted circle (16). Springs (20) and (13) bear upon the edges of latch (1). FIG. 3 shows a pictorial view of the slide plate with its corresponding various sized slots (18) (19) and (23) which are in sequence such that any one of the said slots will engage in its corresponding sized drive shaft of the various sizes and shapes of the lock drive shafts available at present in the differing locks as shown in FIGS. 7, 8, and 9.

Referring again to FIG. 1, slide plate (1) is located in the slot (21) in annulus (25) and is sandwiched between annuli (24) and (26). Slide plate (1) has springs (20) and (13) bearing upon its outer edges to allow some small lateral movement in order to accomodate the differing small changes in the drive shaft locations in the various locks presently available. Spring (13) also engages in the cut out (12) when the slide plate (1) is extended into the lock housing to engage upon, and straddle that particular type of drive shaft appropriate to the lock installation thus providing a fixed locked condition. Spring (13) also engages in slot (14) when it is further extended into the lock housing to engage in the smaller rectangulat type drive shaft as shown in FIG. 8 when it engages in slot (19). When the slot (23) is used to hold the drive shaft of a double dead bolt lock as shown in FIG. 9 the slide plate (1) is held in position by bearing upon the lock handle assembly.

FIG. 4 shows the latching device in its withdrawn condition in which the drive shaft (11) is clear to move in any rotated direction to open or close the door lock. Pin (17) prevents the slide plate (1) from being fully withdrawn from the slot (21).

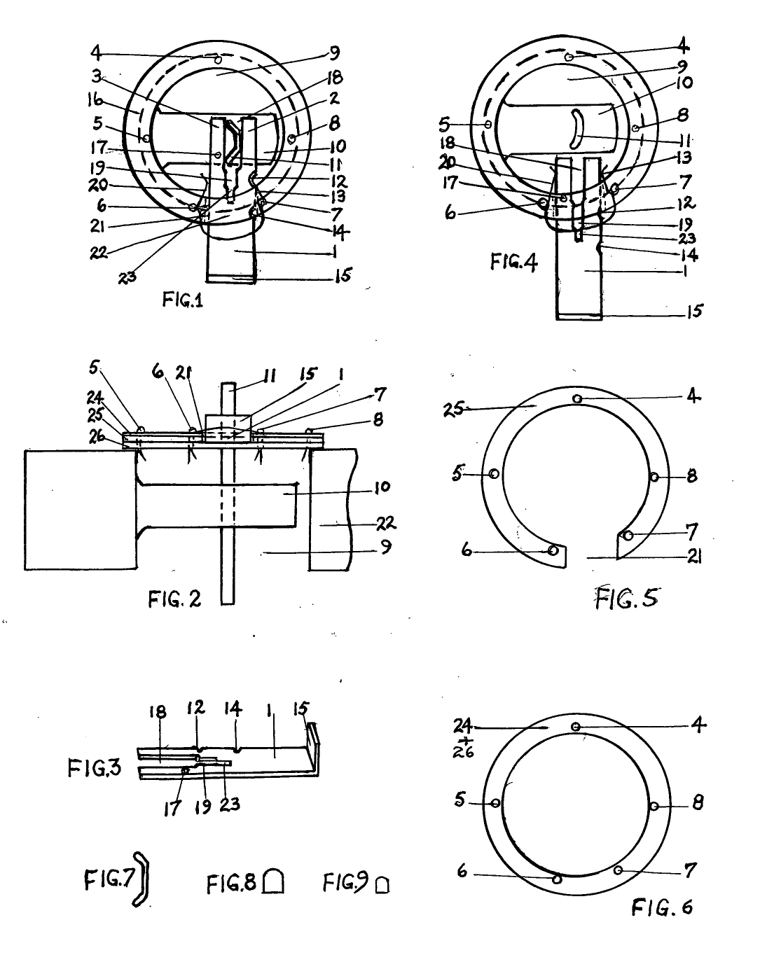

FIG. 2 shows a side or elevation view of the latching device looking up or down from the bottom or the top of the door through the door into the lock housing mounting hole (9) in which the assembly of annuli (24) (25) and (26) are being shown held in place in the lock mounting hole (9) by the cotter pins (5) (6) (7) and (8) and with the slide plate (11) with is angled push end (15) engaged in slot (21) and with this whole assembly shown in relationship to the drive shaft (11) and the lock mechanism (10).

FIG. 7 shows the type of drive shaft (11) as shown in FIG. 4 which engages in slot (18). This type of drive shaft is normally used in a spring bolt lock.

FIG. 8 shows the type of drive shaft normally used in a single dead bolt lock which drive shaft would engage in slot (19) as shown in FIGS. 1 and 4.

FIG. 9 shows the type of drive shaft used in a double dead bolt lock which drive shaft would engage in slot (23).

These above drive shafts shown cover most of the lock assembly dive shafts abailable at present.

FIG. 10 shows a pictorial view of the latch with the lock handle assembly comprising (27) (28) and (29) with its mounting bolts (30) and (31) pivoted at the top end of the latch assembly which when this lock handle assembly is lowered into its normal position and the bolts are driven home into the lock assembly this said assembly clamps the latching device into place on the door.

What is claimed is:

1. a latching device which can latch on to any spring bolt, single dead bolt or double dead bolt by employing a means of straddling the said locks drive shafts by means of a slotted slide plate thus in this described manner holding the lock in an immovable locked condition in an inside door controlled and secured lock operation which cannot be breached by any means from outside the door upon which the lock is mounted by using any lock operating means such as keys, push buttons or electronic means which latching device comprises a precise assembly of metal annuli, or metal casting, or plastic moulding, which differing forms accomodate a sais slotted slide plate such that this slotted slide plate can be slid into the the inner lock volume such that the slotted slide plate can engage upon the various types of differing lock drive shafts thus holding that specifically selected drive shaft in contacts with the latching device slide plate and thus the lock housing and so holding the drive shaft appripriate to that lock in a maximum security locked condition, the said latching device comprising:—
a) an assembly of annuli pinned together and having such diameters of the annuli that when attached to the existing lock mechanism the larger of the annulus diameters extend out from the lock handle assembly diameter when the lock is fully assembled on the door, being part of a doorway, the smaller diameters extend into the lock mounting hole space, the assembly being such that a slot id formed by cutting out a section of the circumference of the center annulus of the annuli assembly.
b) A slide plate mounted within a slot ib an assembly of annuli such that this slide plate can engage upon any form of drive shaft peculiar to any type of lock mounted on a door.
c) A slide plate having metal pins attached in a precise location such that the said slide plate cannot be removed from the slot in the annuli assembly.
d) An arrangement of springs which bear upon the outer edges of the said slide plate which springs guide the slide plate and hold it in successive positions these positions depending upon the type of drive shaft on to which the slide plate straddles.

2. The latching device as described in claim 1 wherein the housing of the latching device is made of a metal casting having similat features and controls as that for the annular assembly means described above.

3. A latching device as described in claim 1 wherein the housing of the latching device is made of a plastic moulding having similar features and controls as that described for the annuli assembly means.
